(19) United States
(12) Patent Application Publication
(10) Pub. No.: US 2005/0125744 A1
(43) Pub. Date: Jun. 9, 2005

(54) Systems and methods for providing menu availability help information to computer users

(76) Inventors: Scott E. Hubbard, Wichita, KS (US); William A. Hetrick, Wichita, KS (US)

Correspondence Address: LSI LOGIC CORPORATION, 1621 BARBER LANE, MS: D-106, MILPITAS, CA, 95035, US

(21) Appl. No.: 10/728,206

(22) Filed: Dec. 4, 2003

(51) Int. Cl. G06F 3/00

(52) U.S. Cl. 715/824; 715/810; 715/808; 715/809; 715/705; 715/708; 715/715

(57) ABSTRACT

Systems and methods for automatically providing assistance to a user of a system controlled through menus. Features and aspects hereof include detecting user input requesting information regarding an unselectable (or grayed-out) menu item presently displayed. The user input may comprise hovering the cursor over the unselectable item, right clicking the unselectable item, clicking another menu item on the same menu requesting the information, or other indicia of the user's request for reasons and/or remedies for the unselectable item. A message containing an explanation of the reason for unavailability of the grayed-out menu item and/or possible remedies therefore is displayed. In a particular embodiment, the system comprises a management system and a peripheral device such as a storage system or a network appliance. In another embodiment, the system may provide similar user interface features in an application program operable on a user's computer.

### BACKGROUND OF THE INVENTION

1. Field of the Invention

The present application relates to the field of user interfaces for computer programs and more specifically relates to methods and structure for presenting menu availability help information to a user of a computer graphical user interface.

2. Discussion of Related Art

Many modem computer systems employ user interface hardware incorporating a display, a pointing device, and often a keyboard. Typical pointing devices include trackballs, mice, styluses, joysticks, touch screens, light pens, digitizers, and touch pads as known in the art.

Typically the pointing device is manipulated by a user. The computer system tracks movements of the pointing device and positions a cursor on the display in accordance with operation of the pointing device. The pointing device also typically has one or more buttons or switches that are operated by the user when the user wishes the computer system to act. Operation of these buttons or switches is known as a “click” or, in specific terms for an alternate (often physically the rightmost button) as a “right click.”

Most modem software operating on such computer systems is menu-driven. A graphical user interface (GUI) presents menus and a cursor positioned according to the pointer device input. Pull-down menus are common in the art. Pull-down menus typically provide a list of parent menu titles or icons, often displayed in a horizontal row across the display. When a click is detected while the cursor is in a predetermined area associated with a menu title or icon, detailed menu selections associated with that menu are displayed as a list perpendicular to the list of parent menu tiles or icons (hence “pulled down”).

In order to avoid confusion, it is common in many such graphical user interfaces that actions in a menu are displayed in the same order and position within the list even if some of these actions are unselectable or disabled given the state of the computer system or the application program presenting the user interface. It has become common to display selectable (also referred to herein as enabled, available or active) actions in one font or appearance on the display; and unselectable (also referred to herein as disabled, unavailable or inactive) actions in a second font. Unselectable actions are often displayed in a low-contrast gray-on-gray font; unselectable actions are therefore referred to as “grayed-out” choices. For example, but not by way of limitation, Microsoft Internet Explorer displays unavailable or unselectable choices in a low-contrast font while available choices are displayed in a higher contrast black-on-gray font. Many applications also have toolbars having rows of icons, each of which represents an action. In like manner, these toolbar action choices may also be grayed-out when not available. As used herein, “menu” and “toolbar” may be considered substantially equivalent. Icons of a toolbar are essentially the equivalent of menu items of a menu. Other equivalent techniques using different colors to distinguish active from inactive choices are also well known as a matter of design choice.

In another user interface technique, many computer systems known in the art are capable of detecting that a cursor has been left over a particular icon without a “click” for a time exceeding a threshold. This event is known as the cursor “hovering” over a menu item. For example, in various versions of the Microsoft Windows operating system and Microsoft application programs, when a cursor is detected hovering over an icon on the taskbar, a so-called “tooltip” window is displayed giving information such as the filename and/or application name associated with that icon.

Such user interface techniques are widely used in operating systems and application programs as discussed above. However, it has also become common for peripheral devices that require user interaction to use similar user interface techniques. For example, many network devices (also referred to as “network appliances”) found in modem computer networks, including switches, routers, cable and DSL modems, firewalls, and wireless access points, have no keyboard or display interface of their own but provide such graphical user interfaces through a management user interface program—often a Web browser client program such as Microsoft Internet Explorer accessed over the network of which they are a part. Or, for example, storage subsystems may require user interaction for managerial and administrative functions and present a similar graphical user interface to an administrative user at a workstation coupled to the storage subsystem to permit such interaction.

Regardless of the application, users confronted with a grayed-out action choice on a menu or a grayed-out icon on a toolbar can be uncertain why that choice is unavailable and what, if anything, can be done to make the choice available. User uncertainty is particularly prevalent among unskilled users such as those unfamiliar with the system or peripheral device and its menus and toolbars.

It is desirable to provide assistance to users in a simple, easy to use manner such that even novice users can more readily learn to operate the menu or toolbar and its associated software. It is therefore an ongoing problem to improve the user interfacing features of graphical user interfaces where certain features may be enabled (accessible) and others disabled (inaccessible) to more simply provide help and explanatory information to the user.

### SUMMARY OF THE INVENTION

The present invention solves the above and other problems, thereby advancing the state of the useful arts, by providing an improved graphical user interface in which help information is presented for unselectable options in the interface.

In accordance with features and aspects hereof, a system may have pull down menus where some menu items may be grayed-out depending upon the state of the system. The system detects a cursor hovering over grayed-out actions in menus. When such a hover is detected, a message explaining why the choice is unavailable is displayed in a tooltip window. Another aspect hereof provide an additional menu item that is always enabled and when, clicked, displays information regarding all menu items that are grayed out within the context of the particular pull-down menu structure. Still other aspects hereof provide that information regarding reasons and remedies for a grayed out item may be revealed by right-clicking the grayed out menu item.

In a particular embodiment, the system is a management system capable of controlling a remote peripheral device such as a network appliance controlled over a network or a remote storage system controlled over its host communication medium. In an alternative embodiment, the system is self-contained and provides such an improved user interface for application programs operating on that system.

A first feature hereof provides a method of automatically providing assistance to a system user comprising the steps of: displaying a menu comprising a plurality of menu items; detecting a user request for information regarding an unselectable menu item of the plurality of menu items; determining information regarding the unselectable menu item in response to the detection of the user request; and displaying a message containing the information regarding the unselectable menu item in response to the user request.

Another aspect hereof further provides that the unselectable menu item is displayed in a font different from a font used to display other menu items of the plurality of menu items.

Another aspect hereof further provides that the information regarding the unselectable menu item is determined dynamically as a function of a system status.

Another aspect hereof further provides that the step of detecting a user request further comprises: detecting a user pointer indicia hovering over the unselectable menu item.

Another aspect hereof further provides that the step of detecting a user request further comprises: detecting a user right click on the unselectable menu item.

Another aspect hereof further provides that the step of determining information further comprises: determining a reason for the unselectability of the unselectable menu item.

Another aspect hereof further provides that the step of determining information further comprises: determining remedies for the unselectability of the unselectable menu item.

Another feature hereof provides a system comprising: a display for presenting graphical user interfaces to a user; a pointing device for receiving user input; a managing task coupled to the display and to the pointing device and including GUI features for presenting a menu comprising a plurality of menu items such that at least one menu item of the plurality of menu items is an unselectable menu item; and a managed task communicatively coupled to the managing task for providing information regarding the plurality of menu items, and such that the information includes information regarding the unselectable menu item, and such that the managing task is adapted to present the information regarding the unselectable menu item in response to user input from the pointing device.

Another aspect hereof further provides that the managing task is responsive to sensing hovering of the pointing device over the unselectable menu item.

Another aspect hereof further provides that the managing task is responsive to sensing right clicking of the pointing device on the unselectable menu item.

Another aspect hereof further provides that the managing task is responsive to sensing clicking of the pointing device a selectable menu item of the plurality of menu items that requests information regarding the unselectable menu item.

Another aspect hereof further provides a reason table coupled to the managing task and storing detailed information regarding the reasons for unselectability of the unselectable menu item such that the managing task is adapted to present the detailed information regarding the reasons for unselectability to a user in response to user input from the pointing device.

Another aspect hereof further provides that the information regarding the unselectable menu item includes a reason code indicating the reason for the unselectability of the unselectable menu item and provides that the reason table is accessible using the reason code as an index.

Another aspect hereof further provides that the managing task is operable in a management system, and provides that the managed task is operable in a managed system, and provides that the system further comprises: a communication medium coupling the managed task to the managing task.

Another aspect hereof further provides a reason table in the management system coupled to the managing task and storing detailed information regarding the reasons for unselectability of the unselectable menu item such that the managing task is adapted to present the detailed information regarding the reasons for unselectability to a user in response to user input from the pointing device.

Another aspect hereof further provides that the information regarding the unselectable menu item includes a reason code indicating the reason for the unselectability of the unselectable menu item and such that the reason table is accessible using the reason code as an index.

### BRIEF DESCRIPTION OF THE DRAWINGS

FIG. 1 is an exemplary block diagram of a management system coupled through a communication medium to a managed device.

FIG. 2 is an exemplary flowchart of tasks undertaken by a managed device in response to a request by a management system to open a particular menu.

FIG. 3 is an exemplary flowchart of tasks undertaken by a management system to display and operate a control menu in a managed device.

FIG. 4 is a depiction of an exemplary display of embodiments hereof featuring a pull down menu with a message explaining why a particular choice is not available.

FIG. 5 is an exemplary block diagram of a stand-alone system providing features and aspects hereof for application programs operating in a system.

### DETAILED DESCRIPTION OF THE DRAWINGS

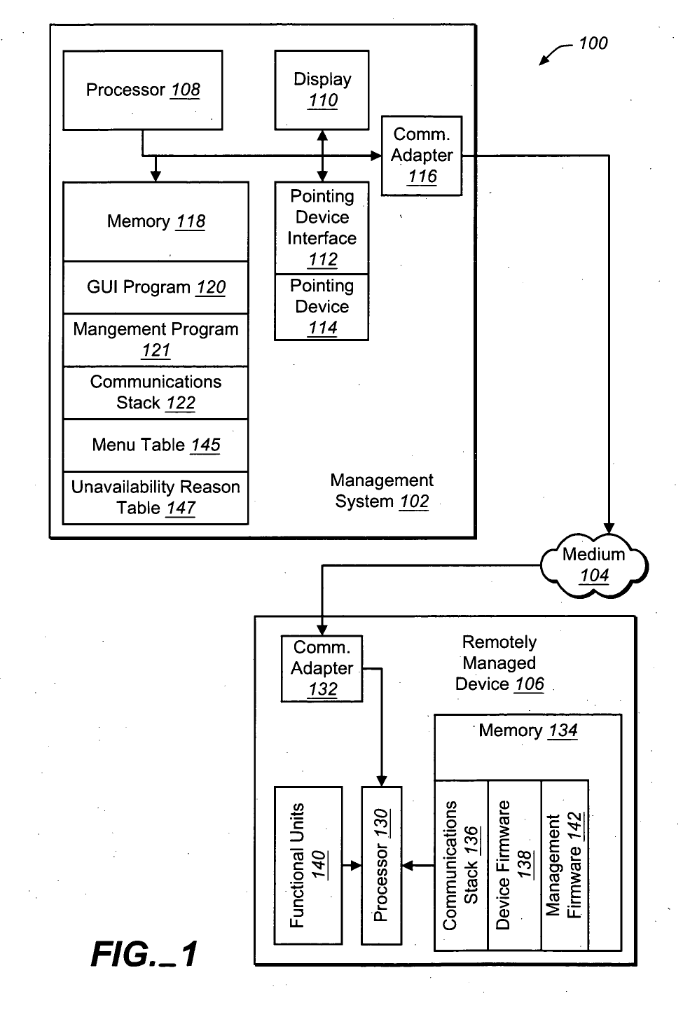

FIG. 1 is an exemplary block diagram of a system 100 having a management system 102 coupled through a communication medium 104 to a managed device 106. As noted above, such a system 100 may include network device management, storage device management or management of any manageable peripheral device coupled to the management system 102. Communication medium 104 may therefore include network communication media (such as WAN communication media or LAN communication media), storage subsystem specific communication media (such as SAN fabric or NAS communication media), or any other communication media appropriate for communications between the management system 102 and a managed device 106.

Management system 102 has a processor 108 coupled to a display 110, and coupled through a pointing device interface 112 to a pointing device 114. Processor 108 is also coupled to a communication interface 116 and a memory system 118. Memory system 118 may include one or more levels of various types of memories including, for example, random access memory (RAM), read only memory (ROM), electrically erasable and programmable read only memory (EEPROM), flash programmable memory, and disk memory as known in the art of computing devices. Memory 118 has recorded in it a graphical user interface (GUI) program 120, a management program 121 and a communications stack 122. Communications stack 122 contains computer readable code for operating the communication interface 116 to communicate with managed device 106 over the communication medium 104. GUI program 120 includes code for positioning a cursor on the display 110 in accordance with user operation of the pointing device 114 through the pointing device interface 112.

Managed device 106 also has a processor 130 coupled to a communication interface 132 and a memory system 134. Memory system 134 may comprise similar levels of similar type of memory devices as those discussed above. Memory 134 has recorded within it code readable by processor 130 of a communications stack 136 for operating communication interface 132, and device specific firmware 138 for controlling additional functional units 140 of the managed device 106. Additional functional units 140 vary with the type of managed device, for example if device 106 is an 802.11G wireless access point, the additional functional units include a wireless transmitter and receiver. Or, if the managed device 106 is a storage subsystem, the additional functional units may include storage devices and associated controllers. Memory system 134 also has recorded within it management firmware 142 for allowing the management system 102 to control one or more features or control variables of the managed device 106.

When a user desires to control device 106, management program 121 is run on management system 102. Management program 121, operating on processor 108 establishes communication through communication adapter 116, communication medium 102, and communication interface 132 to management firmware 142 running on processor 130 of device 106.

Memory 118 of management system 102 may include a menu table 145 and an unavailability reason table 147. Menu table 145 is a repository that may contain menu item names and other parameters for each menu item for a menu or toolbar to be presently displayed by GUI program 120. Included in the information may be flags indicating that a corresponding menu item is presently unselectable (disabled) or selectable (enabled). If disabled, the information in the menu table for the unselectable menu item may include a reason code indicating the reason for the present disabled status of the menu item. The reason table 147 may include textual information regarding reasons for particular menu items being presently disabled and/or may contain textual information explaining possible remedial actions to enable the disabled menu item. The reason table 147 may be indexed by a reason code provided by the managed device 106 (as discussed further herein below). Those skilled in the art will recognize that the menu table 145 and the reason table 147 may contain detailed, voluminous textual information corresponding to menu items and to particular reason codes. Such detailed, voluminous textual information may require more storage space than may be desirable to allocate in the memory 134 of managed device 106 and hence may, as a matter of design choice, may be retained only on the larger memory 118 of the management system 102 as shown in FIG. 1. In one aspect, the managed device 106 returns status code or reason codes to management system 102 (via adapter 132, medium 104 and adapter 116) indicating why a particular feature or operation is not presently available (and hence grayed out in a corresponding menu or toolbar). The management system 102 then translates the provided reason code into appropriate messages using the reason table 147 and the menu table 145. Alternatively, the menu table 145 and reason table 147 may be stored within memory 134 of the managed device 106. The textual information may then be returned from the managed device 106 to the management program 121 in response to requests. Such matters of design choice are readily apparent to those of ordinary skill in the art.

In general, a user of management system 102 may initiate management operations for managed device 106 by invoking management program 121. Program 121 may then interact with management firmware 142 to present menus as defined by information retrieved from the managed device 106 and retained in the menu table 145. The management program 121 requests “opening” of a menu and management firmware 142 may respond to the request by returning appropriate information to present a particular, identified menu. The returned information may be in the form of a structured record that may include indices and codes representing the present state of the managed device and the menu or toolbar to be presently displayed. Included in such a record may be status or reason codes indicating reasons that particular menu items may be unavailable. The various indices and codes may be utilized by the management system (in conjunction with the menu table 145 and the reason table 147) to present the proper menu to the user.

Management program 121 may then use GUI 120 to present on display 110 a menu with item names flagged as in an available state in a first font, and item names flagged as in an unavailable state in a second font. For example, in a common exemplary embodiment, the second font is a low contrast, gray-over-gray, font or “grayed-out” while enabled or selectable menu items are displayed in a higher contrast color and/or font scheme.

The GUI program 120 tracks manipulation of the pointing device 114 and moves a cursor on the display 110 in accordance therewith. Should the cursor be detected hovering over an unavailable menu item, the unavailability reason code associated with that menu item (as provided by the managed device 106 and retained in the menu table 145) may be used as an index to locate a textual message in the unavailability reason table 147. The textual message from the unavailability reason table 147 is then displayed in a tooltip window on the display 110. The textual message may include information explaining why the menu item is not available for selection and/or information for making the corresponding item selectable.

In one aspect, cursor hovering may be detected when a cursor has been left on the indicated menu item without movement for more than a predetermined threshold time. Another aspect hereof provides that a menu item maybe presented on each menu and is always enabled to provide information regarding reasons and remedies for menu items on the corresponding menu that are presently grayed out. In another aspect, a user may “right click” a disabled menu item (i.e., click a different button or switch on the pointer device) to indicate a desire for information on the reasons for disabling of disabled menu items.

Managed device 106 may determine the reason code for a menu item presently disabled in accordance with the present state of the managed device 106 or other aspects of the system 100. The reason code determination may therefore be dynamic and reflect present conditions of the system 100 or of the device 106. As the system status changes or the device status changes, a disabled menu item may be enabled or the reason for disabling (i.e., the reason code) may be changed. Such changes may be communicated between the management system 102 and the managed device 106 through well known asynchronous communication and event processing techniques.

As discussed above, one typical embodiment provides that the managed device returns indices representing menus to be presented. An attached management system (i.e., host system) may translate those indices into menu text and graphics to be presented to the user. The identified menu may include enabled as well as disabled (grayed out) menu items. Status codes and reason codes for grayed out items of menus are provided by the managed device to permit the management system to alter the menu display according to present status of the managed device. Alternatively, the managed device may serve completed HTML information to present the proper menu on the user's display—i.e., the managed device may provide HTML services directly to the user's Web browser client. In such an alternate embodiment, the managed device stores the voluminous textual information for the collection of menus and corresponding menu items as well as the reason and remedy textual information to be presented when the user requests such information (by the various methods discussed herein).

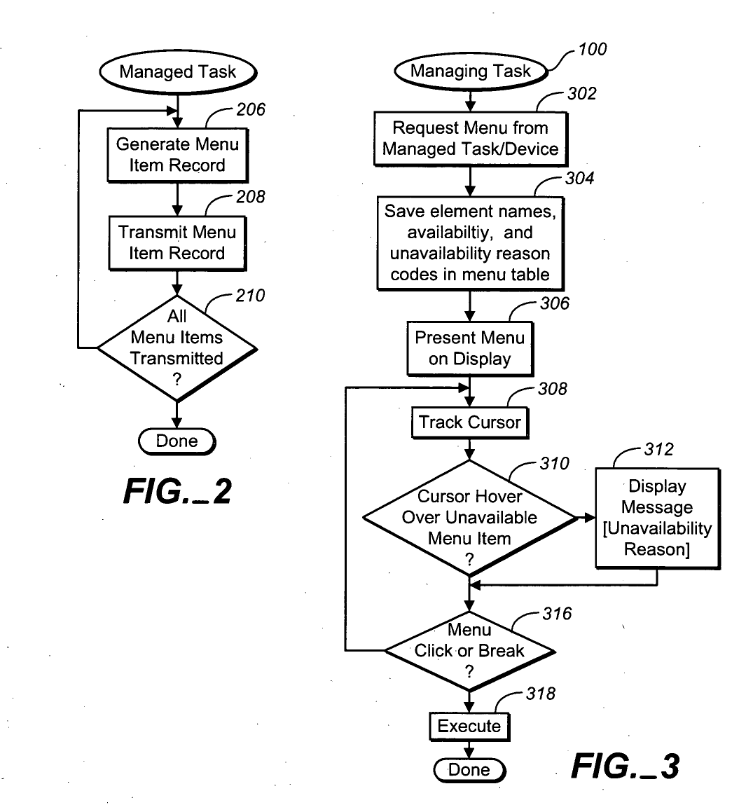

FIGS. 2 and 3 are flowcharts describing cooperating methods in accordance with features and aspects hereof for communications between the management system and a managed device to provide information on unselected menu items. FIG. 3 represents exemplary processing within a management system while FIG. 2 represents corresponding exemplary processing within the managed device. Referring first to FIG. 3, element 302 is operable to request a menu to be displayed from the managed device—i.e., to “open” a menu. The managed device will respond with information on each menu item in the menu to be displayed. The returned information, as noted above may include menu item names, flags indicative of availability of the item, and, if unavailable, a reason code for each unavailable menu item. Element 304 then saves this returned information in a menu table for later reference by the GUI elements of the management system. The returned menu item information is then formatted and presented on the user's display by element 306—i.e., by a GUI process or program on the management system.

Elements 308-316 are then iteratively operable to track cursor movements through the pointer device and to present reasons and/or remedies for disabled menu items in accordance with features and aspects hereof. Specifically, element 308 detects and tracks motion of the cursor. If element 310 detects that the cursor has hovered over a disabled menu item, element 312 is operable to locate the reason code information in the saved menu item information (in the menu table). The reason code so located may then be used to locate, format and present the reason or remedy information to the user. Element 316 then checks for a click or other means of selecting a selectable menu item. Until such a click is detected, processing continues by looping through elements 310 through 316. When a click is detected by element 316, element 318 executes an appropriate operation corresponding to the selectable menu item clicked. Associating such an action with a menu item and executing the associated action are features well known to those skilled in the art. Exemplary of such operations may be the opening of yet another menu, the setting of a toggled parameter, execution of an associated program, display of information, etc. Processing of the method of FIG. 3 may resume in response to requests to present or open another menu.

FIG. 2 represents cooperative processing within a managed device in response to a menu open request from the management system. Element 206 generates a menu item record for a first menu item of the requested (opened) menu. As noted, the menu record may contain menu information including an item name or label, flags indicating present availability or unavailability and, if unavailable, a reason code for the item's unavailability. Further, as noted, the menu item information may be dynamically generated based upon state information of the managed device or other attributes of the entire system. Element 208 then transmits the generated record to the requesting process (i.e., to the management system requesting the menu). Element 210 then determines if additional menu items are to be generated and transmitted for the requested menu. If so, processing of the method loops back to element 206 to process a next menu item. Otherwise, the method completes to be restarted in response to another menu open request.

Those of ordinary skill in the art will recognize a variety of equivalent methods for cooperative processing between a management system and a managed device to provide the desired dynamic generation of menu items, including, dynamic enabling and disabling of menu items with corresponding reason codes for disabled items. The methods of FIGS. 2 and 3 are therefore intended merely as representative of such methods.

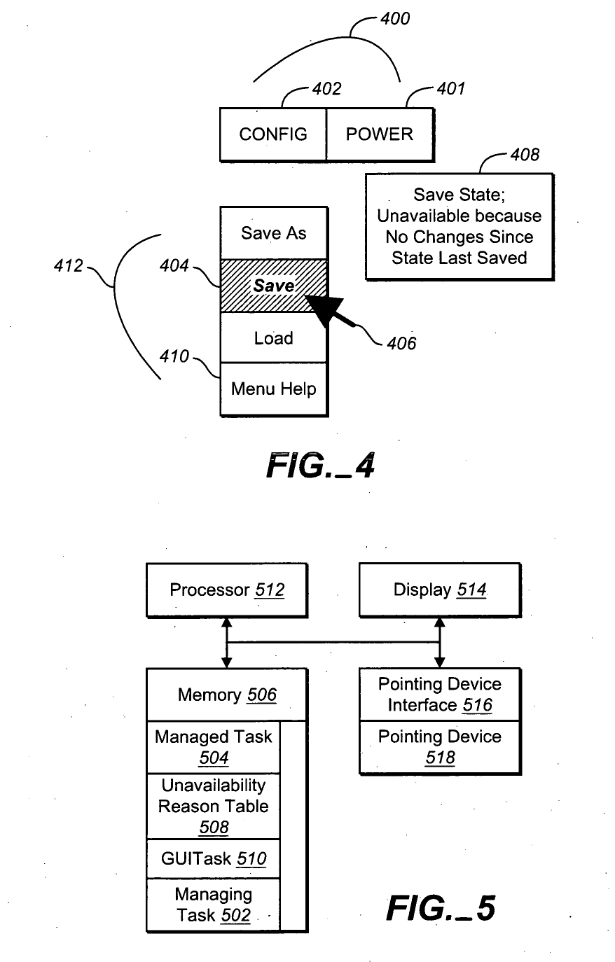

An exemplary menu display is illustrated in FIG. 4. In this illustration, a menu 400 has been displayed consisting of two items: CONFIG 402 and POWER 401. The CONFIG menu item 402 has been selected, causing display of a submenu as a pull down menu 412. Among the menu items of the pull down menu 412 is a “save” menu item 404 which has been displayed in a different font and grayed-out to indicate that it is unavailable. A cursor 406 has been detected hovering over this menu item, and an unavailability reason has been displayed in a tooltip box 408.

As noted above, in alternative embodiments, a user may right click the disabled menu item (i.e., “save” menu item 404) to generate the reason/remedy information in tooltip box 408. Numerous other equivalent displays will be apparent to those of ordinary skill in the art. FIG. 4 is therefore intended as merely representative of one exemplary menu display.

In another aspect hereof, a specific menu item 410 (“Menu Help”) may be included in a displayed menu 412 such that selection of that menu item provides a tooltip box (i.e., 408) with helpful information regarding disabled (grayed out) items of the corresponding menu. Each menu may include such a menu item to provide reason and remedy information for menu items presently disabled on its corresponding menu or toolbar.

FIG. 5 is a block diagram of an alternative embodiment of features and aspects hereof to provide simpler help information to users of a computer program regarding disabled (unselectable) menu items of a displayed menu. In FIG. 5, a managing task 502 and a managed task 504 may coexist in the same memory system 506 as an unavailability reason table 508 and GUI 510. The managing task and managed task are loosely analogous to the management system and managed device discussed above with respect to FIGS. 1 through 3. In the alternative embodiment of FIG. 5, the managed task 504 may simply be another program operable in the same computing device as managing task 502 or even threads or subfunctions of the same task. This alternate embodiment may therefore be used to provide similar features for dynamic enablement and disablement of menu features coupled with simple user interfacing to provide reason and remedy information in any program or system that includes menu graphical user interfacing.

In this embodiment, processor 512 executes the GUI 510 to track, through pointing device interface 516, manipulation of pointing device 518, a cursor on display 514. In this embodiment, managed task 504 may include parts of an application program package, while managing task 502 may include other parts of the same application program package. As above, when a cursor is detected hovering over an unavailable menu item, a helpful message is displayed indicating a reason for unavailability of the menu item and/or possible remedial actions. Similarly, a disabled item may be right-clicked to reveal the reasons and remedies for its present disabled state. Further, a menu item may be included with each menu and is always enabled such that, when clicked, it reveals the reasons and remedies for menu items on the same menu that are presently disabled or grayed out.

The system of FIG. 5 represents a system in which the management features and presentation to a user are integrated within a single system. For example, the system may be a standard personal computer or workstation with an application operable therein applying features and aspects hereof. In addition, the system may be a network, storage or other peripheral appliance with management features built in to serve HTML or other data to a requesting client process that displays the served information.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. In particular, those of ordinary skill in the art will readily recognize that features and aspects hereof may be implemented equivalently in electronic circuits or as suitably programmed instructions of a general or special purpose processor. Such equivalency of circuit and programming designs is well known to those skilled in the art as a matter of design choice. As a result, the invention is not limited to the specific examples and illustrations discussed above, but only by the following claims and their equivalents.

1. A method of automatically providing assistance to a system user comprising the steps of:
displaying a menu comprising a plurality of menu items;
detecting a user request for information regarding an unselectable menu item of the plurality of menu items;
determining information regarding the unselectable menu item in response to the detection of the user request; and
displaying a message containing the information regarding the unselectable menu item in response to the user request.

2. The method of claim 1 wherein the unselectable menu item is displayed in a font different from a font used to display other menu items of the plurality of menu items.

3. The method of claim 1 wherein the information regarding the unselectable menu item is determined dynamically as a function of a system status.

4. The method of claim 1 wherein the step of detecting a user request further comprises:
detecting a user pointer indicia hovering over the unselectable menu item.

5. The method of claim 1 wherein the step of detecting a user request further comprises:
detecting a user right click on the unselectable menu item.

6. The method of claim 1 wherein the step of determining information further comprises:
determining a reason for the unselectability of the unselectable menu item.

7. The method of claim 1 wherein the step of determining information further comprises:
determining remedies for the unselectability of the unselectable menu item.

8. A system comprising:
a display for presenting graphical user interfaces to a user;
a pointing device for receiving user input;
a managing task coupled to the display and to the pointing device and including GUI features for presenting a menu comprising a plurality of menu items wherein at least one menu item of the plurality of menu items is an unselectable menu item; and
a managed task communicatively coupled to the managing task for providing information regarding the plurality of menu items,
wherein the information includes information regarding the unselectable menu item, and
wherein the managing task is adapted to present the information regarding the unselectable menu item in response to user input from the pointing device.

9. The system of claim 8 wherein the managing task is responsive to sensing hovering of the pointing device over the unselectable menu item.

10. The system of claim 8 wherein the managing task is responsive to sensing right clicking of the pointing device on the unselectable menu item.

11. The system of claim 8 wherein the managing task is responsive to sensing clicking of the pointing device a selectable menu item of the plurality of menu items that requests information regarding the unselectable menu item.

12. The system of claim 8 further comprising:
a reason table coupled to the managing task and storing detailed information regarding the reasons for unselectability of the unselectable menu item wherein the managing task is adapted to present the detailed information regarding the reasons for unselectability to a user in response to user input from the pointing device.

13. The system of claim 12 wherein the information regarding the unselectable menu item includes a reason code indicating the reason for the unselectability of the unselectable menu item and wherein the reason table is accessible using the reason code as an index.

14. The system of claim 8
wherein the managing task is operable in a management system, and
wherein the managed task is operable in a managed system, and
wherein the system further comprises:
a communication medium coupling the managed task to the managing task.

15. The system of claim 14 further comprising:
a reason table in the management system coupled to the managing task and storing detailed information regarding the reasons for unselectability of the unselectable menu item wherein the managing task is adapted to present the detailed information regarding the reasons for unselectability to a user in response to user input from the pointing device.

16. The system of claim 15 wherein the information regarding the unselectable menu item includes a reason code indicating the reason for the unselectability of the unselectable menu item and wherein the reason table is accessible using the reason code as an index.
